(19) United States
(12) Patent Application Publication
(10) Pub. No.: US 2003/0055871 A1
(43) Pub. Date: Mar. 20, 2003

(54) Document/poster composition and printing

(76) Inventor: Javier Roses, Valencia (ES)

Correspondence Address: HEWLETT-PACKARD COMPANY, Intellectual Property Administration, P.O. Box 272400, Fort Collins, CO, 80527-2400, US

(21) Appl. No.: 09/917,890

(22) Filed: Jul. 31, 2001

(51) Int. Cl. G06F 15/16

(52) U.S. Cl. 709/203; 715/513

(57) ABSTRACT

Users select images from different web sites to be combined with text and templates to generate a document. A document composition application allows a user to create a document having selected images incorporated therein. The document composition application may provide templates that a user can select from and use to generate a document. The resultant document may then be purchased over the Internet, printed and delivered. Low resolution images may be used when the user selects and customizes an image to be incorporated into the document for faster processing. High resolution images may be used to create a print-quality document that is printed or transmitted to the user. A web basket service is also provided that allows a user to select images from different web sites.

### FIELD OF THE INVENTION

The present invention is generally related to an Internet printing system. More particularly, the present invention is related to collecting images from a plurality of web sites for incorporation into a printable document.

### BACKGROUND OF THE INVENTION

Conventional document composition applications allow users to upload images from a local storage device, such as a hard drive, or access low-resolution images from a web site that are unsuitable for printing. Also, users may right click a mouse on an image in a web page and save the image as a file (e.g., JPEG, PDF, BMP and the like), which may not be suitable for printing or cannot be easily incorporated into a document by the application. Therefore, a user only has access to a limited number of images that may be suitable for composing a document incorporating those images.

There are, however, many web sites which contain images having high resolutions. These web sites generally do not make these high-resolution images available for printing or for downloading for use in creating customized documents for a variety of reasons. These reasons include, among others, that no suitable method for charging for high-resolution images is available, systems are generally not available for fulfilling large format printing orders over the Internet and that conventional document composition applications are monolithic, such that they are typically incompatible with services provided over the Internet.

### SUMMARY OF THE INVENTION

An aspect of the present invention is to provide an improved document generation system. In one respect, the present invention provides a method including the steps of receiving at least one image from a web site; receiving a fee arrangement for the at least one image; incorporating the at least one image in a document; and requesting payment of a fee based on the fee arrangement.

In another respect, the present invention provides a method of generating a document including at least one image received from a remote device. The method includes steps of storing a list of images, wherein the list of images including at least one image stored on the remote device. The method further includes steps of receiving a user-selection of the at least one image included in the list of images; retrieving the at least one image in response to receiving the user-selection; and generating a document including the at least one image.

In another respect the present invention provides a method of generating a document. The method includes steps of generating a template file; generating an image file, including at least one image; generating a document description file, including text; and generating a preview of the document from the template file and including the at least one image and the text.

The methods of the present invention include steps that may be performed by computer-executable instructions executing on a computer-readable medium.

In another respect the present invention provides a web site for generating documents including images received over the Internet. The web site includes at least one computer configured to facilitate purchase of a document. The at least one computer is connected to at least one remote web site through the Internet, and the at least one computer is configured to receive at least one image from the remote web site and generate a document. The document includes the at least one image.

In another respect the present invention provides a system for generating documents. The system includes at least one server, and a plurality of web sites connected to the at least one server through the Internet. The at least one server is operable to store a plurality of images received from the plurality of web sites and generate a document including at least one image received from the plurality of web sites.

In comparison to known prior art, certain embodiments of the invention are capable of achieving certain advantages, including some or all of the following: (1) allowing a large number of high resolution images to be available through the Internet for document composition; (2) providing a document composition service through the Internet; (3) providing printing services through the Internet; (4) web sites having high resolution images may generate revenue for access to their images; and (5) providing document services compatible with other web sites. Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

The present invention is illustrated by way of example and not limitation in the accompanying figures in which like numeral references refer to like elements, and wherein:

FIG. 1 illustrates an exemplary block diagram of a system employing the principles of the present invention;

FIG. 2 illustrates an exemplary block diagram of the document composition web site 110 shown in FIG. 1;

FIG. 3 illustrates an exemplary block diagram of the document composition application 206, shown in FIG. 1;

FIG. 4 illustrates an a flow chart of an exemplary method of creating a document using the creation and selection module 310 shown in FIG. 3;

FIG. 5 illustrates an exemplary web page for facilitating selection of a template;

FIG. 6 illustrates an exemplary web page for selecting images to be incorporated into a selected template;

FIG. 7 illustrates an exemplary web page for editing text to be incorporated into a selected template;

FIG. 8 illustrates an exemplary software structure for the preview and purchase module 320 shown in FIG. 3;

FIG. 9 illustrates a flow chart of an exemplary method for previewing and purchasing a document;

FIG. 10 illustrates an exemplary web page for previewing a document;

FIG. 11 illustrates a flow chart of an exemplary method performed by the image basket application 212; and

FIG. 12 illustrates an exemplary web page displaying an image basket.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

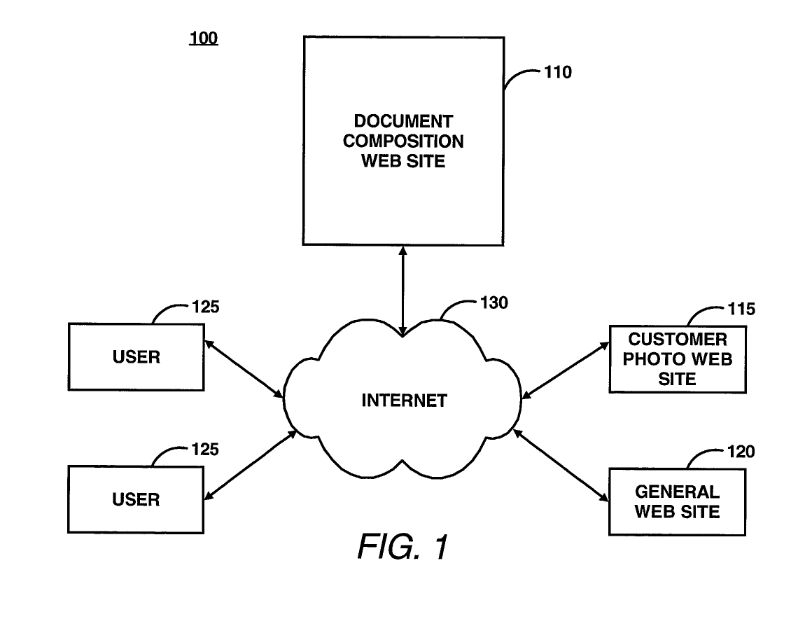

FIG. 1 illustrates a block diagram of an exemplary system employing various principles of the present invention. A document composition web site 110 is connected through the Internet 130 and/or other private networks to other web sites having accessible images, such as a customer photo web site 115 and a general web site 120, and users, such as a user 125. A user 125 may use a conventional device (e.g., computer, personal digital assistant, web phone, and the like) to connect to the document composition web site 110.

The document composition web site 110 provides various services, including the following: a service to create and/or edit documents; a service that provides images that may be incorporated in documents; an image basket service for storing and tracking images, which may be incorporated in a document from the document composition web site 110 or from other web sites; a document storage service; a service for purchasing documents; and a service for distributing and printing documents. In addition to creating documents and providing images for incorporation in documents, the document composition web site 110 allows a user 125 to select images from other web sites (e.g., photo web site 115 or general web site 120) for incorporation into a document created or edited using the document composition web site 110. Images may include low resolution images, high resolution images (e.g., photographs and the like) and other graphics. Documents may include large documents, such as posters (e.g., C size and the like), and smaller-sized documents. A document may include text, graphics, one or more images and the like. The web site 110 also allows a user 125 to purchase a document, such as after the document is created.

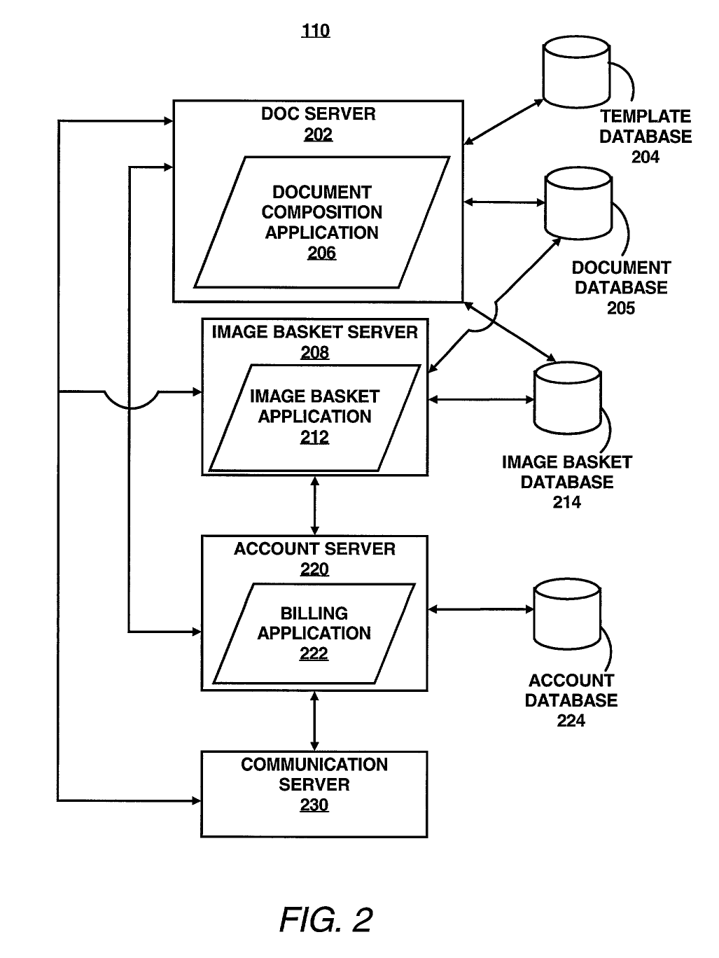

FIG. 2 illustrates a detailed block diagram of the document composition web site 110. The document composition web site 110 includes a document server 202, an image basket server 208, an account server 220 and a communication server 230.

The document server 202 executes a document composition application 206 for creating, editing, viewing, printing and distributing documents. The document server 202 is connected to a template database 204 for storing templates, such as templates for creating documents, and a document database 205 for storing documents, such as documents generated by the document composition application 206. The document composition application 206 may create poster size documents, as well as smaller, conventional-sized documents. The document sever 202 may utilize available printing services, such as E-Kit and POS (poster order service) provided by HEWLETT PACKARD. Additionally, the document server 202 may store documents in conventional file formats (e.g., PDF, JPEG, BMP, and the like) that may be transmitted to a user 125 and readily printed by the user 125.

The image basket server 208 executes an image basket application 212 for keeping track of images that may be incorporated in a document created, printed and/or purchased with the document composition application 206. The image basket server 208 is connected to an image basket database 214, which may store image-related information for each user 125 obtained from a particular web site. Image related information may include a list of images, URLs (e.g., a URL to a web site storing and/or displaying an image), and the like. Image files may be stored in a local storage device in the web site 110. The image basket database may also store configuration information for each remote web site providing images. Configuration information may include billing information for each image, and information regarding allowed usage for each image, such as whether an image basket for this web site may be viewed from another web site; whether an image basket from other web sites may be viewed from this web site; whether images from this web site may be used with images from other web sites; and the like. Also, the image basket application 212 may store information related to documents stored at other web sites in the document database 204. For example, web sites, such as photo web site 115, may include a document storage service. Image basket application 212 may store information related to documents stored at other web sites, such that the web site 110 may access those documents.

The account server 220 executes a conventional billing application 222 for administering billing functions, such as collecting fees from a user 125 for purchased documents and the like. The account server 220 is connected to an account database 224 for storing account and billing information for each user 125. The account information may include user identifications and passwords for logging into the document composition web site 110. The document composition server 202 may be connected to the account server 220 to provide information regarding fee arrangements (e.g., cost per image, cost per document, and the like), such that billing information can be generated and stored in the account database 224.

The communication server 230 facilitates communication with other web sites and each user 125. The communication server may also provide security functions, such as encryption/decryption services, verification services for verifying user identifications and passwords, and the like, such as is known in the art.

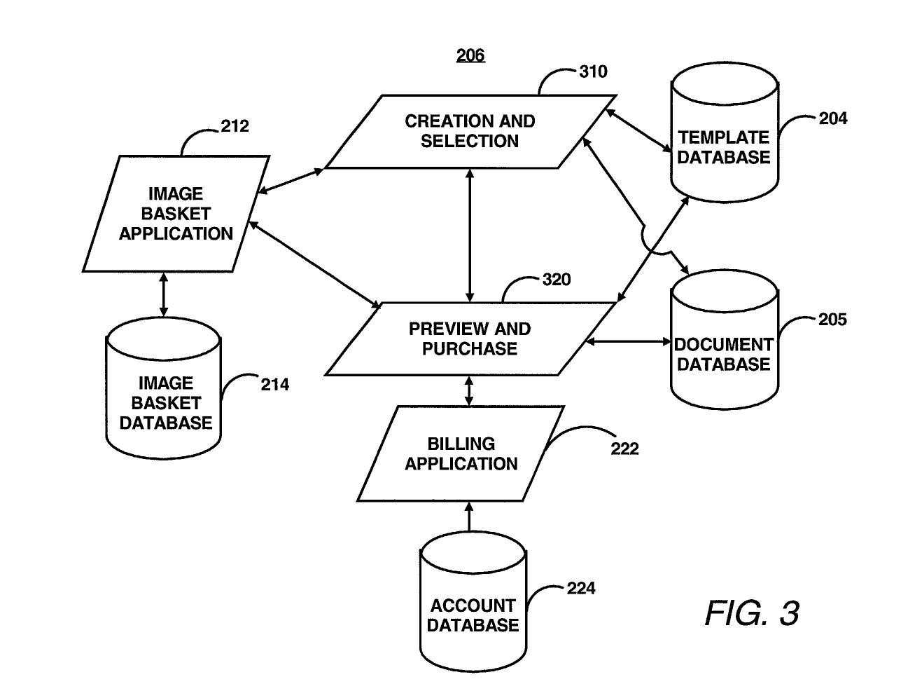

The document composition application 206 is functional to create documents, preview documents, print documents, facilitate purchase of documents, and the like. FIG. 3 illustrates an exemplary block diagram of the document composition application 206. A document creation and selection module 310 is connected to the template database 204 and the document database 205. The document creation and selection module 310 generates documents from templates stored in the template database 204 and may save the documents in the document database 205. Images incorporated in the documents may be retrieved from the image basket database 214 by the image basket application 212. The image basket database 214 may store a list of images including URLs to web sites and the like that store the images. A preview and purchase module 320 provides previews of documents and generates files that may be printed and purchased. The preview and purchase module 320 is connected to the billing application 222 and the account database 224 for generating billing information. The preview and purchase module 320 may prompt a user 125 for payment or provide other billing service.

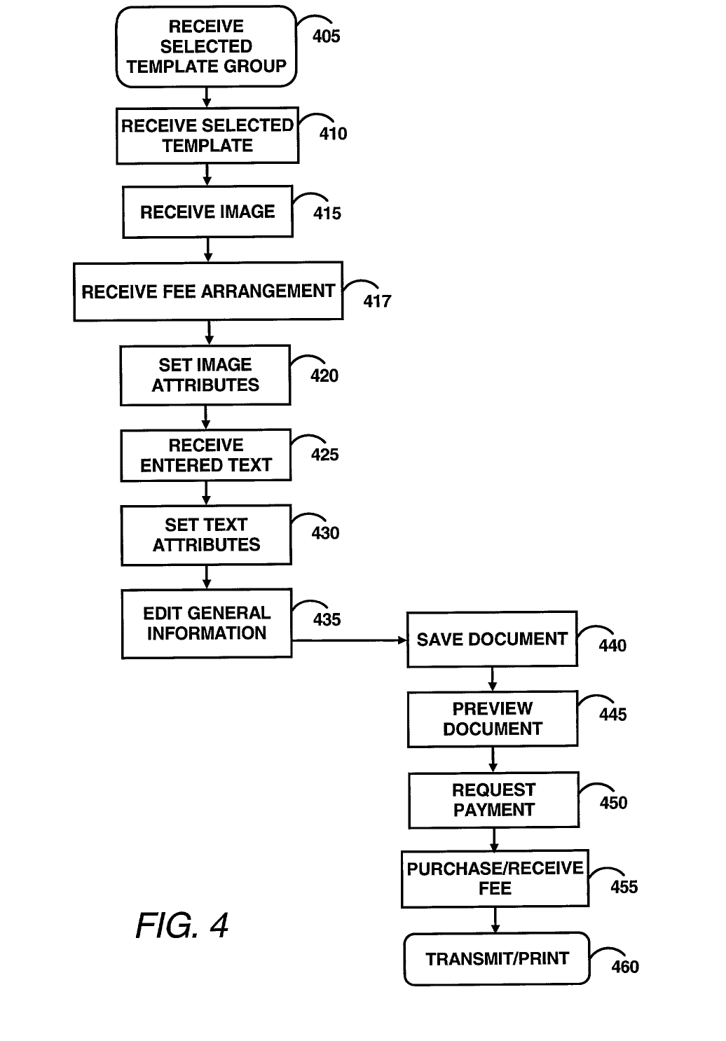

FIG. 4 illustrates a flow chart of an exemplary method of creating a document using the creation and selection module 310. In step 405, a template group is selected by a user 125 and received by the web site 110. A template includes a predefined format for a document. For example, a template may include areas of a document having fixed images and/or text and areas for placing selected images and/or custom text. Templates having similar attributes may be included in a group (e.g., slideshow group, poster group, and the like). A user 125 may select a template group from multiple groups.

In step 410, a template is selected from the group and received by the web site 110. For example, a preview of templates in the selected group are displayed to the user 125 in a web page, and the user 125 selects a displayed template. A preview may include customizable text and selected images in the template and a layout and description of the template.

In step 415, an image to be incorporated in the template is selected and received by the web site 110. For example, the image basket application 212 is called, and images from other web sites or images stored in the web site 110 that may be used by the user 125 are retrieved.

In step 417, a fee arrangement is received for images received from other web sites. Different fee arrangements may be administered by web sites for charging for images selected by a user 125 and used in a document. For each web site, the web site 110 may store a fixed fee for each document created from a remote web site, a percentage of the total cost per document created from a remote web site, a fixed fee for each image used in a document, or a percentage of the total cost per image used in a document. The fee arrangement may be stored in the account database 224.

In step 420, image attributes of the image selected in step 415 are set by the user 125 and received by the web site 110. For example, scaling, cropping, filtering and location within the template for the selected image are set by the user 125. Steps 415 and 420 may be repeated for each image incorporated in the template.

In step 425, text to be included in the template is entered by the user and received by the web site 110. In step 430, attributes (e.g., font, color, size, location and the like) are selected by the user 125 and set by the web site 110. Steps 420 and 425 are repeated for each area of the template that includes entered text.

In step 435, general information for the template may be edited and received by the web site 110. General information includes the color scheme, name of the template/document, description of the document and the like.

In step 440, the template may be saved as a document in the document database 205. The document may also be stored at other web sites having storage capabilities.

In step 445, a preview of the document may be generated if selected by the user 125. In step 450, a request for payment based on a fee arrangement, such as a fee arrangement received in step 417, is generated. In step 455, the user 125 may purchase the document, for example, by paying the fee. In step 460, the purchased document is transmitted to the user 125, for example, in a conventional file format (JPEG, PDF, BMP, and the like) or printed and sent to the user 125. Previewing, printing and purchasing are optional, and may be performed in a different sequence. Also, it will be apparent to one of ordinary skill in the art that many of the steps of the method shown in FIG. 4 may be performed in an order other than illustrated and/or repeated. For example, a template may be selected in step 410 and images and text may be selected. Then, the user 125 may decide to select another template prior to saving the document. Thereafter, steps 410 and subsequent steps may be repeated. Also, for example, after selecting a template the user 125 may set image attributes (step 420), select text (step 425) and go back and set image attributes (step 420) again. These and other variations will be apparent to one of ordinary skill in the art.

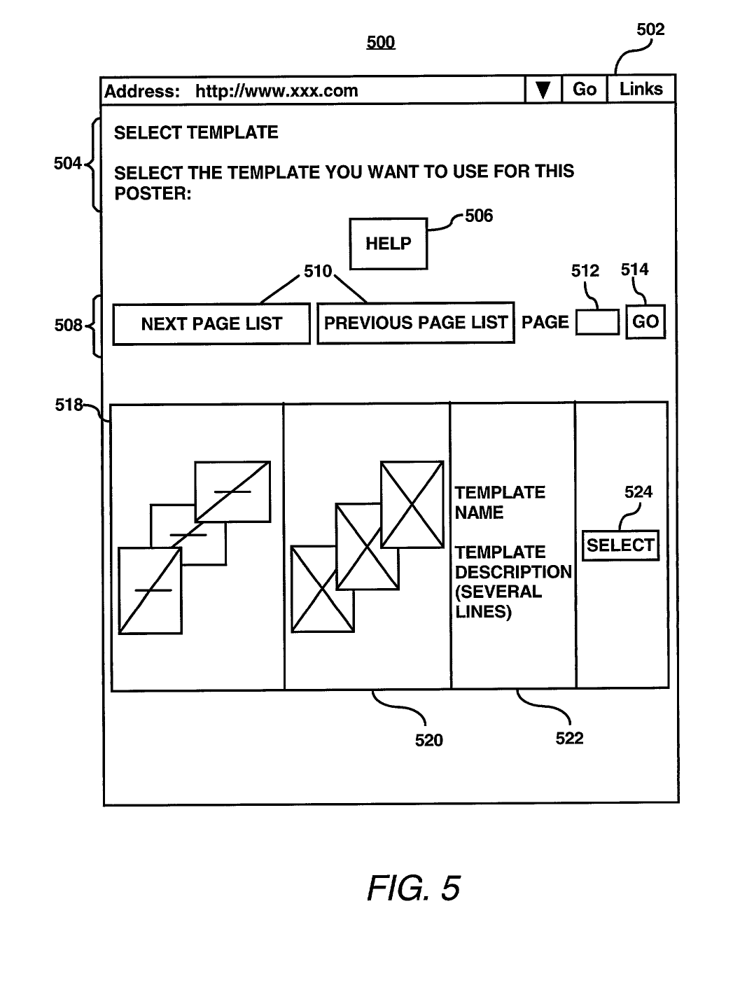

FIG. 5 illustrates an exemplary web page 500 displayed by the web site 110 for facilitating selection of a template, such as performed in step 410 in FIG. 4, after a template group is selected using a similar web page. Web page 500 includes a conventional web browser 502 installed on the device used by the user 125 to access the web site 110. A header 504 and a help button 506 may be included for assisting the user 125 to use the web page 500. A navigation area 508 may include buttons 510, page input 512 and “Go” button 514 for navigating to different templates, which may be selected by the user 125. A template selection area includes a preview 518 of a template, an edit view 520 of the template, a template name and description 522 and a “Select” button 524 for selecting the template. The preview 518 may include images and text that can be edited. The edit view 520 may illustrate the areas of the template where selected images and custom text may be placed. A user presses the “Select” button 524 to select the template for editing.

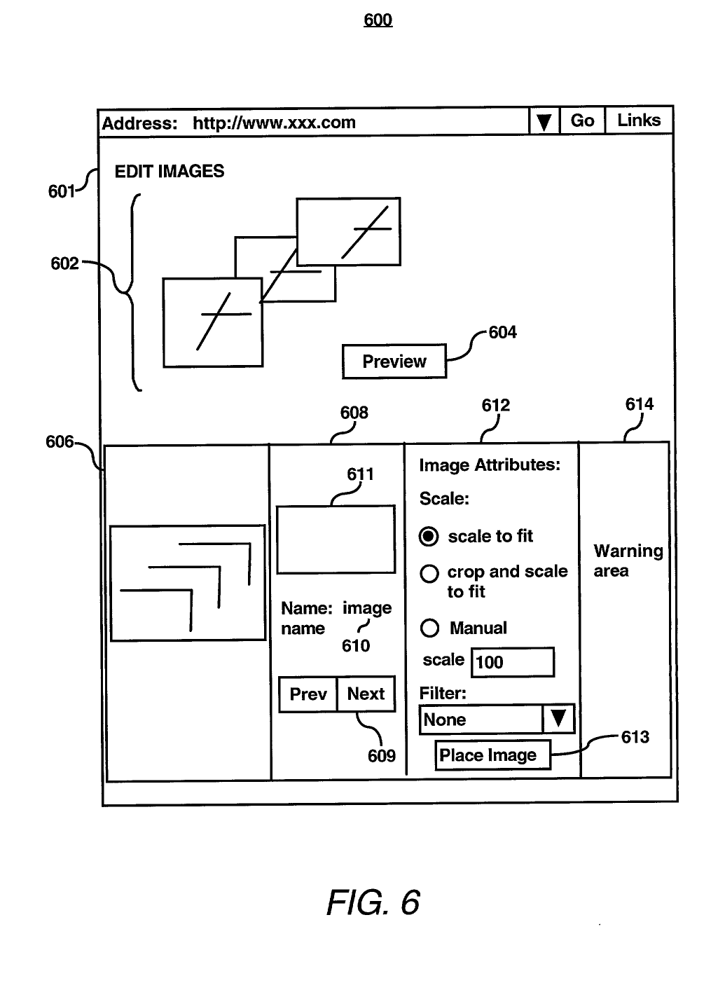

FIG. 6 illustrates an exemplary web page 600 for selecting images to be incorporated into a selected template, such as a template selected using the web page 500. A header 601 describes the web page 600. A preview 602 includes an exemplary preview of the selected template with images and text. An image placement area 606 facilitates placement of an image selected using an image selection area 608. The image selection area 608 includes navigation buttons 609 and an image name 610 of a displayed image 611. The navigation buttons 609 allow the user 125 to navigate through images in an image basket for the user 125. The user 125 selects attributes (e.g., scaling, cropping, conventional image filtering, and the like) for an image in the attributes area 612. When the attributes are set, a “Place Image” button is pressed to place the image in the position selected in the image placement are 606. A warning area 614 displays warning messages when appropriate. For example, warnings, such as “image does not fit in selected area” and the like may be displayed in the warning area 614. The user 125 may press a “Preview” button 604 to view a preview of a document with the edited images.

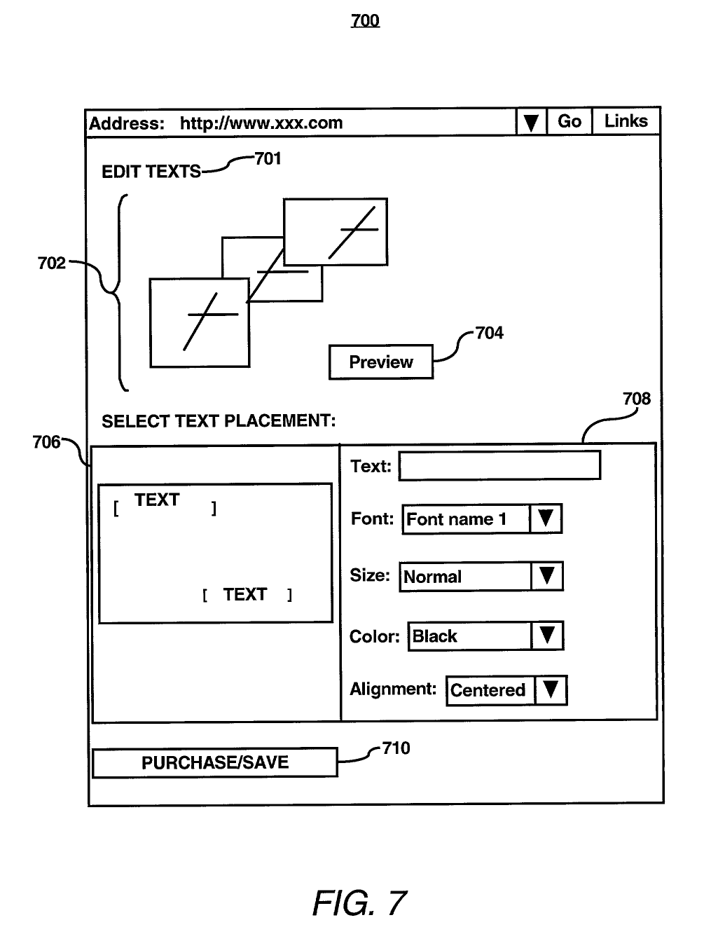

FIG. 7 illustrates an exemplary web page 700 for editing text to be incorporated into a selected template, such as a template selected using the web page 500. A header 701 describes the web page 700. A preview 702 includes an exemplary preview of the selected template with images (e.g., images selected using the web page 600) and text. An image placement area 706 facilitates placement of text entered in a text selection area 708. The user 125 enters text and selects text attributes (e.g., font, size, color, alignment, location, and the like) for the selected text. The user 125 may press a “Preview” button 704 to view a preview of a document with the edited text and images, such as the images selected using the web page 600. The user 125 presses a “Purchase/Save” button 710 to purchase and save a document with the selected images and text. A similar web page may be used to edit the general information edited in step 435 (shown in FIG. 4).

The document composition application 206 may also be invoked from other web sites (e.g., web sites 115 and 120 shown in FIG. 1). For example, the photo web site may display a web page to a user 125 that includes a “Create Document” button next to an image that may be added to an image basket for the user 125. The document composition application 206 may be invoked when the user 125 selects the “Create Document” button, and the user may be given access to documents stored in the web site 110 and/or stored in the photo web site 15 or other web sites. The web site 110 may store configuration information for each web site connected to web site 110. Configuration may include whether documents created by a user 125 that are stored in the web site 110 or other web sites may be accessed at the web site that is invoking the document composition application 206. An “Add Image” button may also be displayed next to an image at the photo web site 115 or another web site, such that a user 125 can add the image to the image basket.

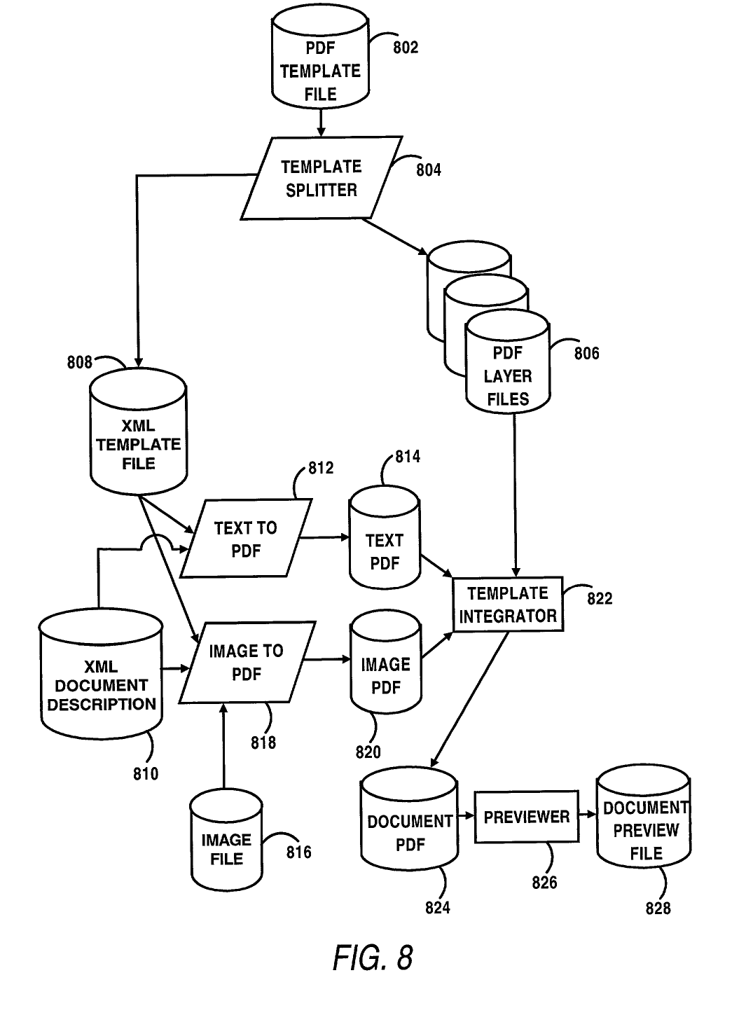

The document composition application 206 includes templates, which are edited with selected images and text as shown in FIG. 4, in order to generate documents that may be previewed and purchased. FIG. 8 illustrates an exemplary software structure for the preview and purchase module 320 (shown in FIG. 3) that allows a user to preview, purchase and print documents.

A template PDF file 802 is created that includes multiple pages for each layer of a template. Layers may include at least the following: background of the template, images that need to be placed by the user, objects that are placed on top of the images (e.g., logos, text and the like), images that cover the objects or the images placed by the user, text to be placed by the user and text in a predetermined location. The template PDF file also includes a list of template fixed items (e.g., fixed text and images), modifiable text (e.g., text entered by a user), and modifiable images (e.g., images selected by a user).

The template splitter module 804 generates multiple PDF layer files 806 from the template PDF file 802. Each of the PDF layer files 806 include a layer of the template defined in the template PDF file 802. The template splitter module 804 also generates an XML (extensible markup language) template file 808 including a description of the template to be used to create the document. The description of the template includes a list of text (e.g., fixed text) and their attributes (e.g., color, font, size, location, and the like) to be used in the document; a list of images (e.g., fixed images) to be used in the document and their attributes (e.g., scaling, cropping, filters, location, and the like); and an order of integration of the PDF layer files 806 with the text and the images. For example, the order of integration may include text and images that are integrated into a particular file of the PDF layer files 806.

A preview of the document created by the document composition application 206 is generated from the PDF layer files 806, the XML template file 808, an XML document description file 810 and an XML image file 816. The XML document description file 810 includes the following: an identification (e.g., file name) of a template to be used, a list of text and their attributes to be used in the document, and a list of images to be used in the document and their attributes. The list of images and text may include text entered by the user and images selected by the user. The document description file 810 and the template file 808 may include redundant information (e.g., text, images and attributes). The XML image file 816 may include an image file having a low resolution image and retrieved from a universal resource location (URL) (e.g., an address on the Internet) defined in the template. Image file 816 may include multiple images. Preferably, the image file 816 includes low resolution images to increase the processing speed to generate a preview of the document created with the document composition application 206. However, high resolution images may be used. Also, the images may have been received from remote web sites or retrieved from a local storage device.

From the XML template file 808 and the XML document description file 810, a TextToPDF module 812 extracts text and corresponding attributes for each text in the files 808 and 810 to create a text PDF (portable document format) file 814 that includes a page with the text in the appropriate position and with the appropriate attributes. If the text is bigger than the allotted space for the text, the TextToPDF module 812 may generate a warning to the user. The TextToPDF module 812 may include a conventional PDF library, such as GLANCE PDF.

An ImageToPDF module 818 extracts the images from the image file 816. From the XML template file 808 and the XML document description file 810, the ImageToPDF module 818 extracts attributes for the images and generates an image PDF file 820, including a page with the image(s) in the appropriate position and with the appropriate attributes. The ImageToPDF module 818 may include a conventional PDF library and/or conventional document editing tools, such as provided by IMAGEMAGIK.

A template integrator module 822 integrates the PDF layer files 806, the text PDF file 814 and the image PDF file 820 into a single page in a document PDF file 824 that may be viewed as a preview of the document created with the document composition application 206. The template integrator module 822 copies all the objects from each of the PDF files 806, 814 and 820 into a single PDF file (i.e., document PDF file 824). Generally, objects in the PDF files include objects generated by the modules (e.g., Xobjects used to integrate images in a stream) and document objects (e.g., text, images, and the like). PDF allows placement of objects in a document as is known in the art, and these objects may be combined into one PDF file.

A previewer module 826 generates a document preview file 828 (e.g., JPEG, PDF, BMP, and the like), which includes a preview of the document created with the document composition application 206, from the document PDF file 824. Based on the page size of the template, the previewer module 826 selects an appropriate resolution that allows the document to be viewed in the format of the document preview file 828. The previewer module 826 may include conventional libraries. The document preview file 828 may be transmitted to the user.

The document preview file 828 may be viewed by the user, but the user may not have access to the document that is being previewed unless the document is purchased. Furthermore, the document preview file 828 may include low resolution images that may not be suitable for printing.

The process to generate a final document, rather than a preview, is the same for generating the preview of the document, but using high resolution images and generating a PDF file (e.g., the document PDF file 824, including high resolution images). For example, high resolution images may be received from remote web site(s) or retrieved from a local storage device and incorporated into a document. The document may be saved in a file (e.g., JPEG, PDF, BMP, and the like) and transmitted to a user if purchased. Also, the document may be printed and sent to a user if purchased. It will be apparent to one of ordinary skill in the art that the software structure for the preview and purchase module 320 may be administered using file formats other than PDF and libraries associated with other file formats.

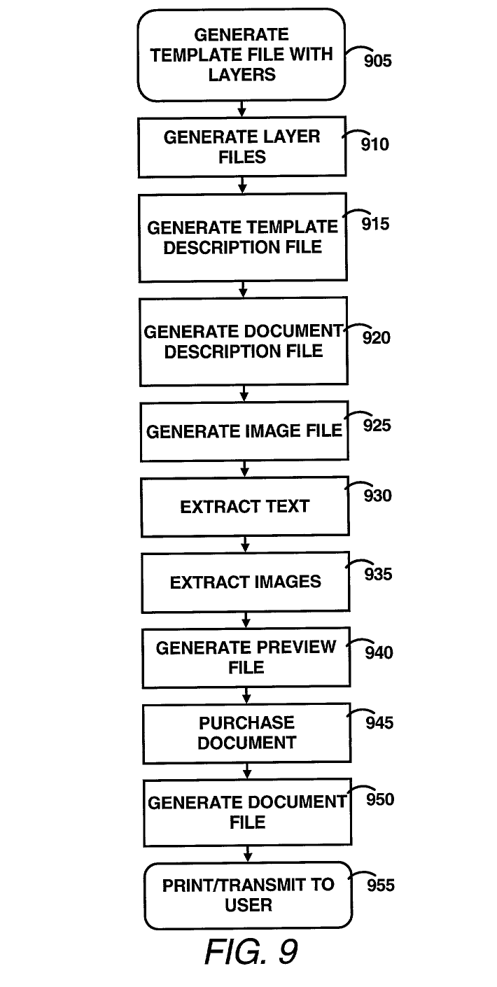

FIG. 9 illustrates an exemplary flow chart of a method for previewing and purchasing a document. In step 905, a template file with layers (e.g., template PDF file 802) is generated. Layers may include sections of the template, as described above. In step 910, multiple layer files are generated (e.g., PDF layer files 806). Each layer file may include information associated with a layer of the template file. In step 915, a template description file is generated (e.g., XML template file 808). The template description file may include text, images and attributes for each layer file. The template description file may be generated once and stored in the template database 204. Steps 905-915 may be performed prior to a user using the document composition service. Therefore, templates and associated files may be generated and stored by the web server prior to the user logging into the web server.

In step 920, a document description file is generated (e.g., XML document description file 810). The document description file may include the template name and other information related to the document. In step 925, an image file is generated (e.g., image file 816) using, for example, the web basket application 212. The image file may include images fixed in the template and images selected by the user. The image file may include images retrieved from the a local storage device and/or URLs of web sites and the like storing images. The images may include low resolution images, which may be processed faster than high resolution images for generating a preview of the document. However, high resolution images may also be used.

In step 930, text and attributes are extracted from the template description file and the document description file generated in steps 915 and 920. In step 935 images and attributes are extracted from the template description file and the image file. In step 940, a preview file is generated from the extracted images, text, attributes and the layer files generated in step 910. In response to purchasing the document (step 945), a document file that may be printed is generated (step 950). For example, a document file is generated using the same steps for generating the preview. However, the document file may include high resolution images received from remote web site(s) and/or retrieved from a local storage device. Low resolution images may also be used in the document file, but the resolution of the image may limit the amount of scaling and other factors that affect the print quality. The document file may be transmitted to the user or printed (step 955). Steps 940 and 945 may be performed in any order and both steps are not required. Also, the document file may be generated after the document is purchased or prior to purchasing the document.

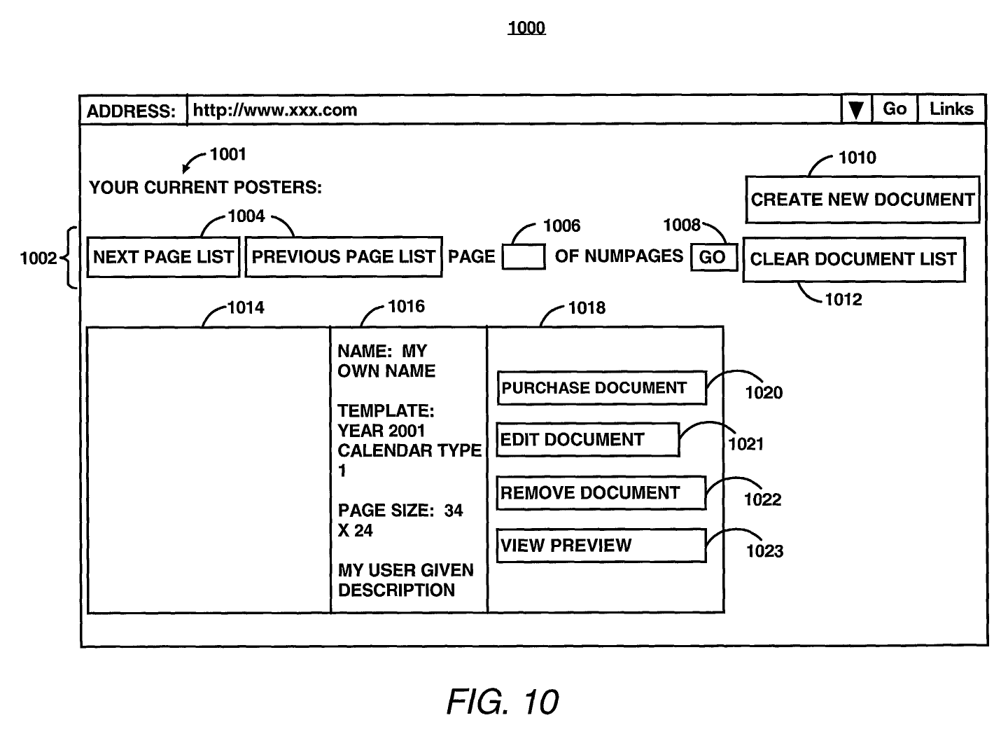

FIG. 10 illustrates an exemplary web page 1000, which may be generated by the web site 110 for previewing a document. A user may preview one or more documents with the web page 1000. A header 1001 describes the web page 1000. A navigation area 1002 may include buttons 1004, page input 1006 and “Go” button 1008 for navigating to different documents, which may be selected by a user for previewing. A “Create New Document” button 1010 may invoke another web page for creating a document, and a “Clear Document List” button 1012 deletes a document list for the user. A preview area 1014 includes a preview of the document. A document description area 1016 includes a description of the document. A user choice area 1018 allows the user to purchase, edit, remove the document from the user's document list and view a preview of the document with buttons 1020-1023 respectively.

The image basket application 212 (shown in FIG. 2) creates and stores an image basket for each user 125 that selects images to be incorporated in a document. An image basket, for example, includes references to images selected by a user 125 (e.g., a list, a table, and the like). Each image basket may be stored in the image basket database 214. The references to images may include references to images stored at the web site 110 or references to images stored at remote web sites (e.g., customer web site 115, general web site 120, and the like) or in other remote devices. References to remotely stored images may include URLs and image identifiers, which may be transmitted to the web site 110 when an image basket needs to be created or updated. Remotely stored image files may also be transmitted to the web site 110 to create a document using the document composition application 206.

Remote web sites (e.g., some photo web sites) may have an internal image basket identifying a list of images (e.g., photos and the like) selected by a user 125. The web sites may transmit an image basket (e.g., in an XML file) that is compatible with an image basket format used by the web site 110. When the file is received by the web site 110, the image basket application 212 updates the image basket for the user 125.

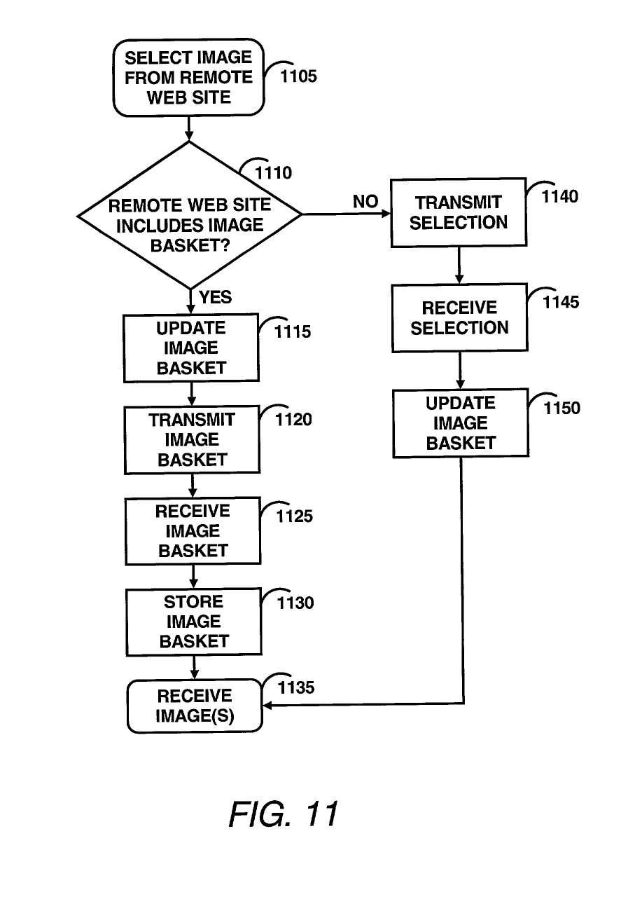

FIG. 11 illustrates a flow chart of an exemplary embodiment of a method performed by the image basket application 212 when a user selects an image from a remote web site. In step 1105, a user 125 selects an image from the remote web site. For example, the web site displays an image in a web page. A user selects an image in the web page by pressing a “Select Image” button next to the displayed image. In step 1110, it is determined whether the remote web site includes an image basket. For example, the web site 110 may store configuration information, such as whether a remote web site includes an image basket and/or document storage services for each remote web site that provides images. In step 1115, if the remote web site includes an image basket, the image basket is updated to include the selected image. In step 1120, the updated image basket is transmitted to the web site 110. In step 1125, the web site receives the image basket from the remote web site, and stores the received image basket (step 1130), for example, in the image basket database 214. The remote web site may transmit the selected image(s) to the web site 110, and the web site 110 receives the selected images (step 1135), such that the user 125 can create a document with the selected image(s). The images may be transmitted to the web site 110 with the image basket or when a document is created with a selected image. The images may be transmitted in a conventional file format and stored locally at the web site 110.

If the remote web site does not include an image basket (as determined in step 1110), the remote web site transmits the selection to the web site 110 (step 1140). For example, the remote web site may send a message to the web site 110 including information regarding selected image(s). The selected images may be transmitted when a document is being created that uses the image(s). It will be apparent to one of ordinary skill in the art that protocols, other than XML, may be used to transmit information between the web site 110 and remote web sites.

In step 1145, the web site 110 receives the selection from the remote web site, and the image basket application 212 may update/create an image basket for the user (e.g., stored in the image basket database 214) with the selection (step 1150). Then, the images corresponding to the selected images in the image basket are transmitted by the remote web site and received by the web site 110 (step 1135).

Alternatively, an image basket for a user 125 may be updated with a user selected image that is stored in the web site 110 and not retrieved from a remote web site. For example, when creating a document with the document composition application 206, a user 125 may select an image stored locally at the web site 110, and the image basket for the user 125 is updated accordingly.

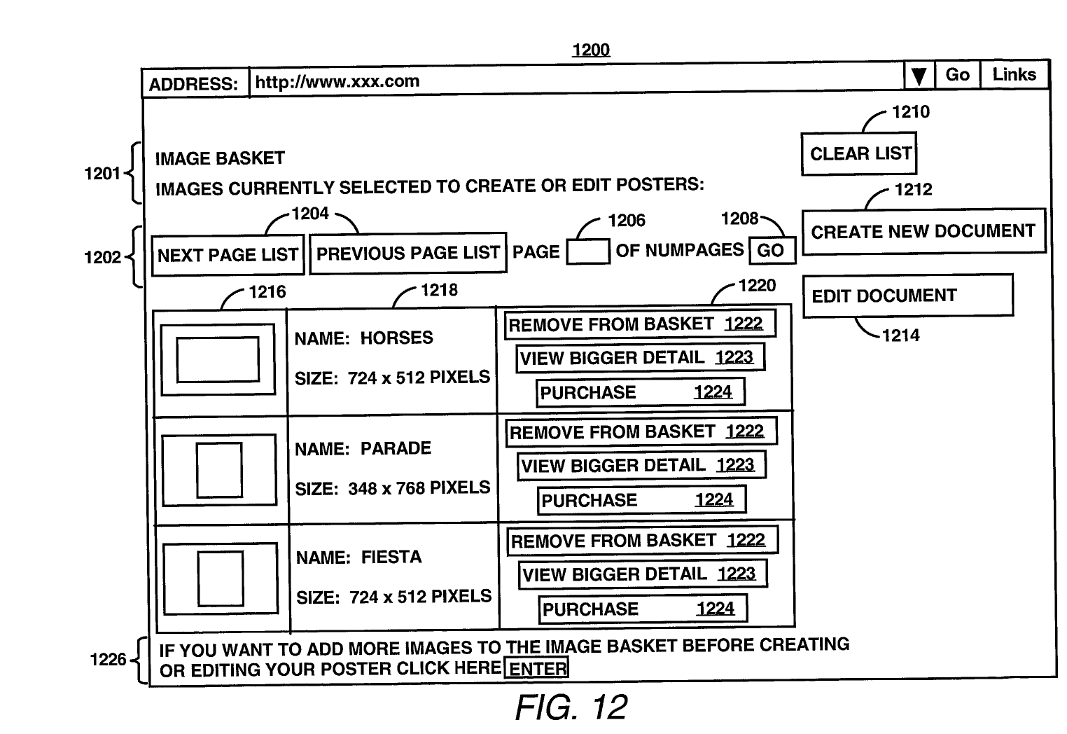

FIG. 12 illustrates an exemplary web page 1200 of an image basket, which may be generated by the web site 110. A header 1201 describes the web page 1200. A navigation area 1202 may include buttons 1204, page input 1206 and “Go” button 1208 for navigating to different images in the image basket. A “Clear List” button 1210 may be used to delete all the images in the image basket. A “Create New Document” button 1212 invokes the document composition application 206 for creating a document, as shown in the flow chart in FIG. 4. An “Edit Document” button 1214 allows a user to edit a current document being created. A preview area 1216 and a description area 1218 include a preview and description of images in the image basket. A user choice area 1220 allows the user 125 to remove a particular image from the image basket, view an image in greater detail than the preview in the preview area 1216, or purchase a document using buttons 1222-1224 respectively. An area 1226 allows the user 125 to add more images to the image basket.

Different fee arrangements may be administered by the remote web sites for charging for images selected by a user 125 and used in a document. For each remote web site, the web site 110 may store a fixed fee for each document created from a remote web site, a percentage of the total cost per document created from a remote web site, a fixed fee for each image used in a document, a percentage of the total cost per image used in a document.

The methods described above can be performed by a computer program. The computer program can exist in a variety of forms both active and inactive. For example, the computer program can exist as software comprised of program instructions or statements in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method comprising steps of:
receiving at least one image from a web site;
receiving a fee arrangement for said at least one image;
incorporating said at least one image in a document; and
requesting payment of a fee based on said fee arrangement.

2. The method of claim 1, further comprising steps of:
receiving a user selection of said image from said web site, and
storing said user selection.

3. The method of claim 2, wherein said step of incorporating said image further comprising steps of:
displaying an image basket associated with a user, said image basket including a plurality of user selections of images from a plurality of web sites, said plurality of user selections including said received user selection;
receiving an image selection selected from said displayed image basket, said image selection including a selection of said image received from said web site; and
incorporating said received image in said document.

4. The method of claim 1, further comprising steps of:
receiving an image basket from said web site, said image basket including a list of images selected by a user, wherein said image received from said web site is included on said list; and
storing said image basket.

5. The method of claim 4, wherein said step of incorporating said image further comprising steps of:
displaying said image basket to said user;
receiving an image selection from said displayed image basket, said image selection including a selection of said image received from said web site; and
incorporating said received image in said document.

6. The method of claim 5, wherein said list of images includes images only from said web site.

7. The method of claim 5, wherein said list of images includes images from a plurality of web sites including said web site.

8. The method of claim 1, wherein said step of incorporating said image further comprises a step of creating said document with said incorporated image.

9. The method of claim 1, wherein said step of creating further comprises steps of:
receiving a selection of a template from a plurality of templates; and
creating said document from said template.

10. The method of claim 9, wherein said step of creating further comprises steps of:
receiving a selection of said image from an image basket;
receiving attributes for said selected image; and
incorporating said image in said document based on said attributes.

11. The method of claim 10, wherein said attributes include at least one of location in said document, scaling and cropping.

12. The method of claim 10, wherein said step of creating further comprises steps of:
receiving text;
receiving attributes for said text; and
incorporating said text in said document based on said attributes.

13. The method of claim 12, wherein said attributes include at least one of color, size, font and location.

14. The method of claim 1, further comprising a step of generating a preview of said document.

15. The method of claim 1, further comprising a step of transmitting a file including said document to a user in response to receiving said requested payment.

16. The method of claim 1, further comprising transmitting said document to a user in response to receiving said fee.

17. The method of claim 16, wherein said step of transmitting further comprises transmitting a file including said document.

18. The method of claim 1, further comprising a step of transmitting said document to a print service in response to receiving said fee.

19. A method of generating a document including at least one image received from a remote device, said method comprising steps of:
storing a list of images, said list of images including at least one image stored on said remote device;
receiving a user-selection of said at least one image included in said list of images;
retrieving said at least one image in response to receiving said user-selection; and
generating a document including said at least one image.

20. The method of claim 19, wherein said step of retrieving further comprises steps of:
receiving said at least one image from said remote device;
storing said at least one image; and
retrieving said at least one stored image from said remote device in response to receiving said user-selection.

21. The method of claim 19, wherein said step of receiving a user-selection further comprises steps of:
displaying said list of images, said display including a preview of said at least one image; and
receiving said user-selection of said at least one displayed image.

22. The method of claim 21, further comprising a step of receiving an image file from said remote device including a low resolution image of said at least one image, and said preview includes a display of said low resolution image.

23. The method of claim 22, wherein said step of retrieving further comprises a step of receiving an image file from said remote device including a high resolution image of said at least one image.

24. The method of claim 23, wherein said step of generating a document further comprises a step of generating a document including said high resolution image.

25. The method of claim 19, further comprising a step of:
receiving a selection of a template from a plurality of templates; and
said step of generating said document further comprises generating said document from said selected template.

26. The method of claim 19, further comprising a step of:
receiving attributes for said at least one image; and
said step of generating said document further comprises incorporating said at least one image in said document based on said attributes.

27. The method of claim 26, wherein said attributes include at least one of location of said at least one image in said document, scaling and cropping.

28. The method of claim 19, further comprising steps of:
receiving text;
receiving attributes for said text; and
said step of generating said document further comprises incorporating said text in said document based on said attributes.

29. The method of claim 28, wherein said attributes include at least one of color, size, font and location.

30. The method of claim 19, wherein said document includes a document having at least a C paper size.

31. The method of claim 19, wherein said remote device is a web site.

32. A method of generating a document, said method comprising steps of:
generating an image file, including at least one image;
generating a document description file, including text; and
generating a preview of said document from a template file, said preview including said at least one image and said text.

33. The method of claim 32, further comprising steps of:
extracting said at least one image from said image file;
extracting said text from said document description file; and
extracting attributes for said at least one image and said text from said document description file.

34. The method of claim 33, wherein said attributes for said text include at least one of color, size, font and location and said attributes for said at least one image include at least one of scaling, cropping and location.

35. The method of claim 34, wherein said template file includes a plurality of layers, said layers including sections of said template, and said method further comprises a step of generating a plurality of layer files, wherein said layer files include information from at least one of said layers.

36. The method of claim 35, wherein said layers include at least one of images, text, and a template background.

37. The method of claim 35, further comprising a step of integrating said extracted at least one image, said extracted text and said plurality of layer files into a first document file.

38. The method of claim 37, wherein said step of generating a preview further comprises generating said preview from said document file.

39. The method of claim 38, wherein said preview including a low resolution image of said at least one image.

40. The method of claim 39, further comprising steps of:
generating a second document file including a high resolution image of said at least one image; and
transmitting said second document file to a printing service.

41. A web site for generating documents including images received over the Internet, said web site comprising:
at least one computer configured to facilitate purchase of a document, said at least one computer being connected to at least one remote web site through the Internet, wherein said at least one computer is configured to receive at least one image from said remote web site and generate a document, said document including said at least one image.

42. The web site of claim 41, wherein said at least one computer generates a template web page for selecting a template from a plurality of templates.

43. The web site of claim 42, wherein said at least one computer generates an image web page for selecting said at least one image from a plurality of images.

44. The web site of claim 43, wherein said at least one computer is configured to generate said document in response to receiving a selection for said template and receiving a selection of said at least one image.

45. The web site of claim 43, wherein said at least one computer is configured to store an image basket for said user, said image basket including a list of images selected by said user from a plurality of web sites, said plurality of web sites including said at least one remote web site and said list of images including said at least one image.

46. The web site of claim 45, wherein said image web page includes a display of said image basket.

47. The web site of claim 41, wherein said at least one computer is configured to store documents generated from said web site.

48. The web site of claim 41, wherein said at least one computer is configured to transmit said document to said user over the Internet in response to said user purchasing said document.

49. The web site of claim 41, wherein said at least one computer is configured to generate a preview of said document in a web page transmitted to said user.

50. A system for generating documents, said system comprising:
at least one server;
a plurality of web sites connected to said at least one server through the Internet, wherein said at least one server is operable to store a plurality of images received from said plurality of web sites and generate a document including at least one image received from said plurality of web sites.

51. The system of claim 50, wherein said at least one server is operable to store a plurality of generated documents, said plurality of generated documents including said document including said at least one image.

52. The system of claim 51, further comprising a plurality of user devices connected to said at least one server, wherein said at least one server is operable to generate said document in response to receiving information from a user device of said plurality of user devices.

53. The system of claim 52, wherein said information includes a selection of said at least one image from a plurality of images.

54. The system of claim 52, wherein said information includes a selection of a template for generating said document.

55. The system of claim 52, wherein said at least one server is operable to store account information for said plurality of users and said plurality of web sites.

56. The system of claim 52, wherein said at least one server is operable to receive payment from said user device for said document.

57. The system of claim 52, wherein said at least one server is operable to transmit said document to said user device in response to receiving said payment.
